(19) United States
(12) Patent Application Publication
(10) Pub. No.: US 2025/0371120 A1
(43) Pub. Date: Dec. 4, 2025

(54) System and method for authenticating users in a computing system

(71) Applicant: Bank of America Corporation, Charlotte, NC (US)

(72) Inventors: Yash Misra, Lucknow (IN); Nimish Ravindra Deshpande, Mumbai (IN); Neha Trehan, Noida (IN); Jasmeet Bhogal, Faridabad (IN)

(21) Appl. No.: 18/680,383

(22) Filed: May 31, 2024

(51) Int. Cl. G06F 21/32; G06F 21/55; G10L 17/26

(52) U.S. Cl. CPC G06F 21/32; G06F 21/552; G10L 17/26

(57) ABSTRACT

In response to receiving a voice call from a user, a new voice spectrogram is generated based on the voice of the calling user. A plurality of phonetic indicators are extracted from the new voice spectrogram and compared to phonetic indicators of a plurality of historic voice spectrograms associated with respective users. When a historic voice spectrogram includes one or more of the phonetic indicators extracted from the new voice spectrogram, it is determined that the identity of the calling user is authenticated. On the other hand, when none of the historic voice spectrograms include the one or more of the phonetic indicators extracted from the new voice spectrogram, it is determined that the identity of the calling user is not authenticated.

### TECHNICAL FIELD

The present disclosure relates generally to network communication, and more specifically to a system and method for authenticating users in a computing system.

### BACKGROUND

When users who are subscribed to receive a product or service call into a call center, no systems and/or mechanisms exist that can authenticate an identity of a calling user based on the voice of the calling user.

### SUMMARY

The system and method implemented by the system as disclosed in the present disclosure provide technical solutions to the technical problems discussed above by intelligently authenticating an identity of a user based on the voice of the user.

For example, the disclosed system and methods provide the practical application of authenticating an identity of a user based on a voice call received from the user. For example, as described in embodiments of the present disclosure, in response to receiving a voice call from a user, an access manager generates a new voice spectrogram based on the voice of the calling user as received in the voice call. The access manager extracts a plurality of phonetic indicators from the new voice spectrogram, wherein each phonetic indicator represents a characteristic of the user’s voice as indicated by the voice signal. The access manager compares the new voice spectrogram with a plurality of the historic voice spectrograms associated with a plurality of users, wherein the comparing comprises searching for each of the phonetic indicators extracted from the new voice spectrogram in each of the historic voice spectrograms. Based on the comparison, the access manager determines whether one or more phonetic indicators extracted from the new voice spectrogram are found in one or more of the historic voice spectrograms. When a historic voice spectrogram include the one or more of the phonetic indicators extracted from the new voice spectrogram, the access manager determines that the identity of the calling user is authenticated. On the other hand, when none of the historic voice spectrograms include the one or more of the phonetic indicators extracted from the new voice spectrogram, the access manager determines that the identity of the calling user is not authenticated.

By intelligently authenticating a user’s identity based only on the voice of the user, the disclosed system and methods avoid unauthorized data interactions requested by unauthorized users from being processed. This raises the data security of the computing system used to process user requests for data interactions. Further, by avoiding processing of data interactions requested by unauthorized users, the disclosed system and methods save processing resources and network resources which would otherwise be used to unnecessarily process the unauthorized data interactions. By saving processing resources, the disclosed system and methods improving performance of computing nodes and systems used to process data interactions requested by users.

Thus, the disclosed system and method generally improve technology associated with authorizing users in a computing network.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure; and

FIG. 2 illustrates a flowchart of an example method for authenticating identity of users, in accordance with one or more embodiments of the present disclosure.

### DETAILED DESCRIPTION

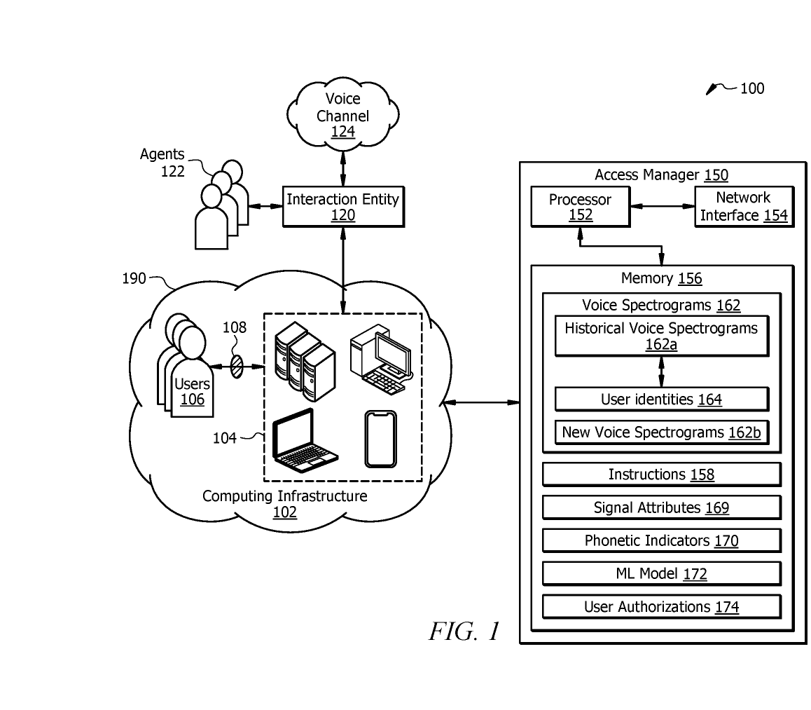

FIG. 1 is a schematic diagram of a system 100, in accordance with certain aspects of the present disclosure. As shown, system 100 includes a computing infrastructure 102 connected to a network 190. Computing infrastructure 102 may include a plurality of hardware and software components. The hardware components may include, but are not limited to, computing nodes 104 such as desktop computers, smartphones, tablet computers, laptop computers, servers and data centers, mainframe computers, virtual reality (VR) headsets, augmented reality (AR) glasses and other hardware devices such as printers, routers, hubs, switches, and memory all connected to the network 190. Software components may include software applications that are run by one or more of the computing nodes 104 including, but not limited to, operating systems, user interface applications, third party software, database management software, service management software, mainframe software, metaverse software, AI tools and other customized software programs (e.g., access manager 150) implementing particular functionalities. For example, software code relating to one or more software applications may be stored in a memory device and one or more processors (e.g., belonging to one or more computing nodes 104) may execute the software code to implement respective functionalities. An example software application run by one or more computing nodes 104 of the computing infrastructure 102 may include the access manager 150. In one embodiment, at least a portion of the computing infrastructure 102 may be representative of an Information Technology (IT) infrastructure of an organization.

One or more of the computing nodes 104 may be operated by a user 106. For example, a computing node 104 may provide a user interface using which a user 106 may operate the computing node 104 to perform data interactions within the computing infrastructure 102. In certain embodiments, one or more users 106 may be registered with an entity that owns or manages the computing infrastructure 102 and may be configured to receive one or more services provided by at least a portion of the computing infrastructure 102. For example, one or more servers in the computing infrastructure 102 may be configured to provide video streaming services. Users 106 may subscribe to receive the video streaming service provided by the respective servers of the computing infrastructure 102. In another example, a user 106 may be registered to store a data file having data objects at a server of the computing infrastructure 102 and perform one or more data interactions associated with the data file such as transferring data objects from the data file to another data file and/or receiving data objects into the data file from another data file.

One or more computing nodes 104 of the computing infrastructure 102 may be representative of a computing system which hosts software applications that may be installed and run locally or may be used to access software applications running on a server (not shown). The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server running one or more software applications to implement respective functionality (e.g., access manager 150) as described below. In certain embodiments, one or more of the computing nodes 104 may run a thin client software application where the processing is directed by the thin client but largely performed by a central entity such as a server (not shown).

Network 190, in general, may be a wide area network (WAN), a personal area network (PAN), a cellular network, or any other technology that allows devices to communicate electronically with other devices. In one or more embodiments, network 190 may be the Internet.

In certain embodiments, an entity that owns and/or manages the computing infrastructure or a portion thereof may provide one or more services which may be consumed by users 106 registered with/subscribed to the entity. For example, one or more servers that are part of the computing infrastructure 102 may be configured to provide video streaming services. Users 106 may subscribe to receive the video streaming service provided by the respective servers. In another example, a user 106 may be registered to store a data file having data objects at a server of the computing infrastructure 102 and perform one or more data interactions associated with the data file such as transferring data objects from the data file to another data file and/or receiving data objects into the data file from another data file.

In certain embodiments, one or more computing nodes 104 of the computing infrastructure 102 may implement an interaction entity 120 that is configured to receive voice calls 108 from users 106. For example, users 106 that are setup to receive one or more services provided by computing nodes 104 of the computing infrastructure 102 may place voice calls 108 to the interaction entity 120 to perform one or more data interactions associated with the services such as manage their services (e.g., add and/or drop services), request information relating to one or more services, raise issues (e.g., complaints) related to the one or more services being received by the users 106, and/or perform data interactions associated with a data file stored at a computing node 104. For example, a user 106 that is registered to receive a video streaming service may call the interaction entity 130 to report an interruption in the service, enquire about shows provided as part of the registration, setup devices that can stream video, subscribe to new channels, drop already subscribed channels and the like. In one embodiment, the interaction entity 130 may support one or more voice channels 124 (e.g., phone numbers, voice chat, video chat, voice data files etc.) that may be used to receive voice calls 108 from users 106. In one embodiment, the interaction entity 120 may provide one or more agents 122 (e.g., one or more of the users 106) that are configured to receive and attend to voice calls 108 received from users 106 on one or more voice channels 124. It may be noted that a voice call 108 may refer to any method by which a user 106 may transmit a voice message and/or conduct a voice/video conversation with an agent 122 at the interaction entity 120.

Generally, when a user 106 places a voice call 108 to the interaction entity 120, an identity of the user 106 needs to be authenticated so that only authorized users 106 are allowed to perform data interactions associated with one or more services provided by the computing infrastructure 102 or a portion thereof. For example, as described above, users 106 may be registered with the computing infrastructure 102 or a portion thereof to receive one or more services provided by the computing infrastructure 102 or a portion thereof. One or more users 106 may be authorized by a service provider of a service to perform one or more data interactions associated with the service. For example, one or more authorized users 106 associated with a particular service provided by one or more computing nodes 104 of the computing infrastructure 102 may be authorized to place voice calls 108 to the interaction entity 120 to perform one or more data interactions associated with the particular service such as manage the service (e.g., add and/or drop service), request information relating to the service, raise issues (e.g., complaints) related to the service, and/or perform other data interactions associated with the service. It is important that an identity of the user 106 who placed a voice call 108 to the interaction entity 120 is authenticated so that only authorized users 106 are allowed to request/conduct data interactions associated with a service.

Generally, when an authorized user 106 places a voice call to the interaction entity 120 to perform a data interaction associated with a service, the authorized user 106 is requested to provide one or more pre-configured authorization credentials that prove the authorized user’s identity. For example, the authorized user 106 may be asked a series of security questions to prove the identity of the authorized user 106. The pre-configured authorization credentials may include answers to the security questions which only the authorized user may possess. For example, the pre-configured authorization credentials may include a passcode, social security number, phone number, residential address, date of birth, etc. The authorized user 106 is allowed to request data interactions associated with a registered service only when the identity of the user is successfully authenticated based on the pre-configured authorization credentials provided by the user 106. In some cases, an imposter (e.g., a hacker) may obtain the authorization credentials of an authorized user 106, wherein the authorization credentials are meant to be used by the authorized user 106 only to prove the user’s identity during a voice call 108 placed to the interaction entity 120. This may allow the imposter to place voice calls to the interaction entity 120 and pretend to be the authorized user 106 by providing the authorization credentials obtained from the authorized user 106. In other words, any person who possesses the authorization credentials of the authorized user 106 may pretend to be the authorized user 106 over a voice call 108 and perform unauthorized data interactions associated with a service which only the authorized user 106 is authorized to perform.

Embodiments of the present disclosure describe techniques for monitoring voice calls 108 placed by a user 106 (e.g., voice calls received at the interaction entity 130), and authenticate an identity of the user 106 based on the voice of the user 106.

At least a portion of the computing infrastructure 102 (e.g., one or more computing nodes 104) may implement an access manager 150 which may be configured to authenticate an identity of a user 106 based on a voice of the user 106 during a voice call 108 placed by the user 106 to an interaction entity 120. The access manager 150 comprises a processor 152, a memory 156, and a network interface 154. The access manager 150 may be configured as shown in FIG. 1 or in any other suitable configuration.

The processor 152 comprises one or more processors operably coupled to the memory 156. The processor 152 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

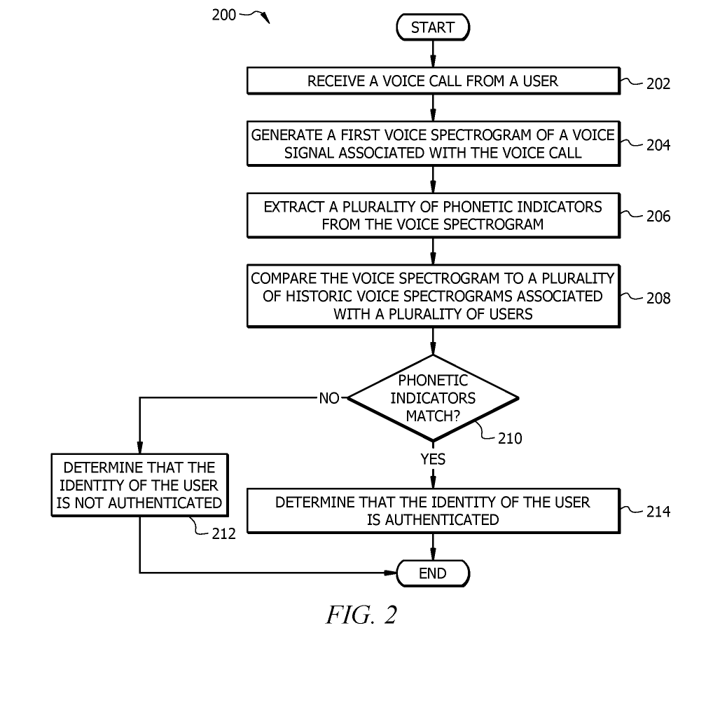

The one or more processors are configured to implement various instructions, such as software instructions. For example, the one or more processors are configured to execute instructions 158 to implement the access manager 150. In this way, processor 152 may be a special-purpose computer designed to implement the functions disclosed herein. In one or more embodiments, the access manager 150 is implemented using logic units, FPGAs, ASICs, DSPs, or any other suitable hardware. The access manager 150 is configured to operate as described with reference to FIG. 2. For example, the processor 152 may be configured to perform at least a portion of the method 200 as described in FIG. 2.

The memory 156 comprises a non-transitory computer-readable medium such as one or more disks, tape drives, or solid-state drives, and may be used as an over-flow data storage device, to store programs when such programs are selected for execution, and to store instructions and data that are read during program execution. The memory 156 may be volatile or non-volatile and may comprise a read-only memory (ROM), random-access memory (RAM), ternary content-addressable memory (TCAM), dynamic random-access memory (DRAM), and static random-access memory (SRAM).

The memory 156 is operable to store voice spectrograms 162 of voice calls 108 received from users 106 including historic voice spectrograms 162 associated with verified voice calls previously placed by authorized users 106 and new voice spectrograms 168 associated with new/unverified voice calls 108 placed by users 106. The memory 156 may be further configured to store user identities 166 of users 106 associated with each historic voice spectrogram 162, phonetic indicators 170, machine learning model 172, user authorizations 174, and instructions 158, and any other data needed to performed operations of the issue manager 150 as described in embodiments of the present disclosure. The instructions 158 may include any suitable set of instructions, logic, rules, or code operable to execute the sandbox manager 150.

The network interface 154 is configured to enable wired and/or wireless communications. The network interface 154 is configured to communicate data between the access manager 150 and other devices, systems, or domains (e.g., interaction entity 120, other computing nodes 104 etc.). For example, the network interface 154 may comprise a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

It may be noted that each of the computing nodes 104 and the interaction entity 120may be implemented like the issue manager 150 shown in FIG.1. For example, each of the computing nodes 104 and the interaction entity 120 may have a respective processor and a memory that stores data and instructions to perform a respective functionality of the computing node 104 and the interaction entity 120 respectively.

In one or more embodiments, the access manager 150 may be configured to authenticate an identity of a user 106 based on a voice call 108 received from the user 106 (e.g., at an interaction entity 120). The access manager 150 may be communicatively coupled to the interaction entity 120 such that the access manager 150 has access to voice calls 108 placed by users 106 to the interaction entity 130. For example, the access manager 150 may be configured to monitor the interaction entity 120 for voice calls 108 placed to the interaction entity 120. In one embodiment, a voice call 108 placed by a user 106 to the interaction entity 120 may include a voice interaction (e.g., voice conversation) between the user 106 and an agent 122 that receives the voice call 108 for the interaction entity 120. In an alternative embodiment, a voice call 108 may include a voice recording (e.g., a voice message) transmitted by the user 106 to the interaction entity 120 using a voice channel 124 such as email, messaging service, social media or any other channel that allows the user 106 to transmit voice to the interaction entity 120.

The access manager 150 may be configured to generate a voice spectrogram 162 (e.g., new voice spectrogram 162b) of a voice call 108 placed by a user 106 to the interaction entity 120, wherein the voice spectrogram 162 is a representation of a voice signal associated with the voice call 108. Generally, a voice spectrogram 162 of a voice signal/audio signal is a visual representation of the spectrum of frequencies associated with the voice signal as the voice signal varies with time. Spectrograms associated with audio signals are often also referred to as sonographs, voiceprints, or voicegrams. In one embodiment, the access manager 150 may be configured to generate a voice spectrogram 162 based on the voice signal associated with the voice of the user 106 from whom the voice call 108 was received. For example, when the voice call 108 includes a voice interaction between the user 106 and an agent 122 associated with the interaction entity (e.g., regardless of who initiated the voice call 108), the access manager 150 may be configured to generate a voice spectrogram 162 based only on the voice signal associated with the voice of the user 106 and ignore the voice signal associated with the voice of the agent 122 who engaged in the voice interaction with the user 106. So, essentially, the voice spectrogram 162 generated for a voice call 108 represents the voice signal associated with the user’s voice from whom the voice call 108 was received.

The access manager 150 may be configured to extract a plurality of phonetic indicators 170 from a voice spectrogram 162, wherein each phonetic indicator represents a characteristic of a user’s voice to whom the voice spectrogram 162 belongs. Example phonetic indicators 170 that may be extracted from a voice spectrogram 162 associated with a user 106 may include, but are not limited to, one or more of pronunciation of one or more stop words, pronunciation of vowels, pronunciation of consonants, pronunciation of numerals, time taken to answer designated security questions, or voice modulation. In one or more embodiments, the access manager 150 may be configured to identify and analyze a plurality of signal attributes 169 from a voice spectrogram 162, wherein a particular signal attribute 169 or a combination of two or more signal attributes 169 may correspond to a phonetic indicator 170. The signal attributes 169 that may be extracted from a voice spectrogram 162 may include, but are not limited to, one or more of voice modulation, pauses, speech duration, breathing, pitch, frequency or loudness. Each phonetic indicator 170 may correspond to a particular signal attribute 169 or a combination of two or more signal attributes 169 extracted from the voice spectrogram. Thus, in one embodiment, the access manager 150 first extracts one or more signal attributes 169 from a candidate voice spectrogram 162 and then identifies one or more phonetic indicators 170 associated with the user 106 based on the extracted signal attributes 169.

In some embodiments, the access manager 150 may be configured to analyze the voice call 108 in real-time or near real-time as a voice interaction (e.g., voice conversation) is being conduct between a user 106 (e.g., a user who initiated the voice call 108) and an agent 122 associated with the interaction entity 120. For example, upon detecting that a voice call 108 has been placed by a user 106 to the interaction entity 120 and that a voice interaction has started between the user and an agent 122 associated with the interaction entity 120, the access manager 150 starts generating a voice spectrogram 162 of the voice interaction and starts extracting the phonetic indicators 170 from the voice spectrogram 162 in real-time or near real-time as the voice interaction is being conducted between the user 106 and the agent 132. In conjunction with generating the voice spectrogram 162 and extracting the phonetic indicators 170, the access manager 150 starts analyzing the phonetic indicators 170 to authenticate an identity of the user 106 in real-time or near real-time. The authentication process of a user 106 based on phonetic indicators 170 extracted from a voice spectrogram 162 of a voice call 108 is described below in more detail. The authentication of the user 106 in real-time or near real-time allows the access manager 150 to promptly verify authorization of the calling user 106 to perform one or more data interactions requested by the user 106 as part of the voice call 108. This allows the access manager 150 to proactively verify user authorization in real-time or near real-time before any data interactions requested during the voice call 108 are processed.

In additional or alternative embodiments, the access manager 150 analyzes a recording of a voice call 108 (e.g., a voice interaction between the user 106 and an agent 132, a voice message etc.) to generate the voice spectrogram 162 of the voice call 108 and extract phonetic indicators 170 from the generated voice spectrogram 162.

In one or more embodiments, the access manager 150 may be configured to authenticate an identity of a user 106 based on the voice spectrogram 162 (e.g., new voice spectrogram 162b) associated with the voice signal of the user 106 from a voice call 108. It may be noted that the term “new voice spectrogram 162b” refers to a voice spectrogram 162 of an unverified voice call 108. In other words, a new voice spectrogram 162b is a voice spectrogram 162 extracted from a voice call 108 where the identity of the calling user 106 has not yet been authenticated. To authenticate the identity of the user 106, the access manager 150 compares the new voice spectrogram 162b to a plurality of historic voice spectrograms 162a associated with verified voice signals of authorized users 106. In this context, the access manager 150 may have access to a plurality of historic voice spectrograms 162a (e.g., stored in memory 156), wherein each historic voice spectrogram 162a is a representation of a voice signal associated with a verified voice of a particular authorized user 106. Each historic voice spectrogram 162a is mapped to a unique user identity 164 of a particular authorized user 106. In other words, each historic voice spectrogram 162a represents a verified voice signal of an authorized user 106. In one embodiment, a historic voice spectrogram 162a may have been extracted from a previously verified voice call 108 of an authorized user 106. In this case, the historic voice spectrogram 162a is a representation of a voice signal associated with a verified voice call previously received from a particular authorized user 106 and known to be associated with the particular authorized user 106.

Comparing the new voice spectrogram 162b to the plurality of historic voice spectrograms 162a includes searching for one or more phonetic indicators 170 extracted from the new voice spectrogram 162b in each of the plurality of historic voice spectrograms 162a. When one or more of the phonetic indicators 170 match between the new voice spectrogram 162b and a particular historic voice spectrogram 162a, access manager 150 determines that the identity of the user 106 is authenticated. For example, when one or more of the phonetic indicators 170 extracted from the new voice spectrogram 162b match with respective one or more phonetic indicators 170 associated with a particular historic voice spectrogram 162a, access manager 150 determines that the user 106 to which the new voice spectrogram 162b belongs (e.g., the user who placed the voice call 108) is the authorized user 106 (e.g., as indicated by the user identity 164 mapped to the historic voice spectrogram 162a) mapped to the particular historic voice spectrogram 162a.

To search for a particular phonetic indicator 170 in a historic voice spectrogram 162a, the access manager 150 searches for a particular signal attribute 169 or a combination of two or more signal attributes 169 that correspond to (e.g., represents) the particular phonetic indicator 170. As described above, each phonetic indicator 170 may correspond to (e.g., is represented by) a particular signal attribute 169 or a combination of two or more signal attributes 169 of a voice spectrogram 162. For example, it is likely that a user 106 pronounces a particular word in a same or similar manner every time. The pronunciation of the particular word by the user 106 may be represented by a unique combination of signal values associated with two or more respective signal attributes 169 on a voice spectrogram 162 of the user’s voice. Access manager 150 may leverage the unique combination of values of the two or more signal attributes 169 to determine whether the same user 106 has spoken the particular word. For example, pronunciation of the particular word by the user 106 may be represented by a unique combination of respective values of voice modulation, frequency and pitch in a historic voice spectrogram 162a associated with a verified voice the user 106. When a new voice call 108 is subsequently received from the same user 106 in which the user 106 utters the same particular word, comparing the new voice spectrogram 162b of the new voice call 108 with the historic voice spectrogram 162a associated with the user 106 may yield a match between the same or similar combination of unique combination of respective values of voice modulation, frequency and pitch between the new voice spectrogram 162b and the historic voice spectrogram 162a. This match indicates that the user 106 who placed the new voice call is the same user 106 associated with the historic voice spectrogram 162a.

In one or more embodiments, the access manager 150 determines that the identity of a user 106 who placed the voice call 108 is authenticated in response to determining that at least a threshold number of phonetic indicators 170 extracted from the new voice spectrogram 162b match with respective phonetic indicators 170 associated with a particular historic voice spectrogram 162a. For example, when a threshold number of the phonetic indicators 170 extracted from the new voice spectrogram 162b match with respective phonetic indicators 170 associated with a particular historic voice spectrogram 162a, access manager 150 determines that the user 106 to which the new voice spectrogram 162b belongs (e.g., the user who placed the voice call 108) is the authorized user 106 (e.g., as indicated by the user identity 164 mapped to the historic voice spectrogram 162a) mapped to the particular historic voice spectrogram 162a.

In one or more embodiments, access manager 150 may be configured to authorize data interactions requested by a user 106 who placed a voice call 108 (e.g., to the interaction entity 120). For example, a user 106 may place a voice call 108 and request to perform a data interaction during the voice call 108. In this context, access manager 150 may have access to user authorizations 174 (e.g., stored in memory 156), wherein the user authorizations 174 define a set of data interactions a user 106 is authorized to perform. For example, for each of a plurality of authorized users 106, user authorizations 174 may include a mapping of a user identity 164 of an authorized user 106 and a set of data interactions the user 106 is authorized to perform/request. When a voice call 108 is received from a particular user 106, the access manager 150 first authenticates/verifies the identity of the calling user 106 in the manner described in the above paragraphs. For example, when one or more phonetic indicators 170 extracted from a new voice spectrogram 162b of the voice call 108 match with respective phonetic indicators 170 of a particular historic voice spectrogram 162a, the access manager 150 obtains the user identity 164 mapped to the particular historic voice spectrogram 162a. Once user identity 164 of the calling user 106 is obtained, the access manager 150 looks up the user authorizations 174 for the set of data interactions mapped to the user identity 164 of the calling user. The access manager 150 determines that the calling user 106 is authorized to perform the data interaction requested as part of the voice call 108, when the requested data interaction is one of the data interactions mapped to the user identity 164 of the user 106.

In certain embodiments, the access manager 150 may use a machine learning (ML) model 172 (e.g., an artificial Intelligence (AI) algorithm) to authenticate an identity of a user 106 based on a voice call 108 placed by the user 106. In this context, the ML model 172 may be trained using the historic voice spectrograms 162a and the respective user identities 164 of authorized users 106 to which each historic voice spectrogram 162a belongs. When a new voice call 108 is received from a user 106, the access manager 150 inputs a new voice spectrogram 162b generated based on the new voice call 108 into the trained ML model 172. The trained ML model 172 then compares phonetic indicators 170 between the new voice spectrogram 162b and the historical voice spectrograms 162a to yield a user identity 164 of an authorized user 106.

FIG. 2 illustrates a flowchart of an example method 200 for authenticating identity of users, in accordance with one or more embodiments of the present disclosure. Method 200 may be performed by the access manager 150 shown in FIG. 1.

At operation 202, the access manager 150 detects that a first voice call (e.g., voice call 108) has been initiated by a first user (e.g., user 106).

As described above, the access manager 150 may be communicatively coupled to the interaction entity 120 such that the access manager 150 has access to voice calls 108 placed by users 106 to the interaction entity 130. For example, the access manager 150 may be configured to monitor the interaction entity 120 for voice calls 108 placed to the interaction entity 120. In one embodiment, a voice call 108 placed by a user 106 to the interaction entity 120 may include a voice interaction (e.g., voice conversation) between the user 106 and an agent 122 that receives the voice call 108 for the interaction entity 120. In an alternative embodiment, a voice call 108 may include a voice recording (e.g., a voice message) transmitted by the user 106 to the interaction entity 120 using a voice channel 124 such as email, messaging service, social media or any other channel that allows the user 106 to transmit voice to the interaction entity 120.

At operation 204, the access manager 150 generates a first voice spectrogram (e.g., new voice spectrogram 162b) of a first voice signal associated with the first voice call (e.g., voice call 108), wherein the first voice spectrogram is a representation of the first voice signal associated with the first voice call.

As described above, the access manager 150 may be configured to generate a voice spectrogram 162 (e.g., new voice spectrogram 162b) of a voice call 108 placed by a user 106 to the interaction entity 120, wherein the voice spectrogram 162 is a representation of a voice signal associated with the voice call 108. Generally, a voice spectrogram 162 of a voice signal/audio signal is a visual representation of the spectrum of frequencies associated with the voice signal as the voice signal varies with time. Spectrograms associated with audio signals are often also referred to as sonographs, voiceprints, or voicegrams. In one embodiment, the access manager 150 may be configured to generate a voice spectrogram 162 based on the voice signal associated with the voice of the user 106 from whom the voice call 108 was received. For example, when the voice call 108 includes a voice interaction between the user 106 and an agent 122 associated with the interaction entity (e.g., regardless of who initiated the voice call 108), the access manager 150 may be configured to generate a voice spectrogram 162 based only on the voice signal associated with the voice of the user 106 and ignore the voice signal associated with the voice of the agent 122 who engaged in the voice interaction with the user 106. So, essentially, the voice spectrogram 162 generated for a voice call 108 represents the voice signal associated with the user’s voice from whom the voice call 108 was received.

At operation 206, the access manager 150 extracts a plurality of phonetic indicators 170 from the first voice spectrogram (e.g., new voice spectrogram 162b), wherein each phonetic indicator 170 represents a characteristic of the first user’s voice as indicated by the first voice signal.

As described above, the access manager 150 may be configured to extract a plurality of phonetic indicators 170 from a voice spectrogram 162, wherein each phonetic indicator represents a characteristic of a user’s voice to whom the voice spectrogram 162 belongs. Example phonetic indicators 170 that may be extracted from a voice spectrogram 162 associated with a user 106 may include, but are not limited to, one or more of pronunciation of one or more stop words, pronunciation of vowels, pronunciation of consonants, pronunciation of numerals, time taken to answer designated security questions, or voice modulation. In one or more embodiments, the access manager 150 may be configured to identify and analyze a plurality of signal attributes 169 from a voice spectrogram 162, wherein a particular signal attribute 169 or a combination of two or more signal attributes 169 may correspond to a phonetic indicator 170. The signal attributes 169 that may be extracted from a voice spectrogram 162 may include, but are not limited to, one or more of voice modulation, pauses, speech duration, breathing, pitch, frequency or loudness. Each phonetic indicator 170 may correspond to a particular signal attribute 169 or a combination of two or more signal attributes 169 extracted from the voice spectrogram. Thus, in one embodiment, the access manager 150 first extracts one or more signal attributes 169 from a candidate voice spectrogram 162 and then identifies one or more phonetic indicators 170 associated with the user 106 based on the extracted signal attributes 169.

At operation 208, the access manager 150 compares the first voice spectrogram (e.g., new voice spectrogram 162b) with a plurality of historic voice spectrograms 162a associated with the plurality of users 106, wherein the comparing comprises searching for each of the phonetic indicators 170 extracted from the first voice spectrogram in each of the historic voice spectrograms 162a.

As described above, the access manager 150 may be configured to authenticate an identity of a user 106 based on the voice spectrogram 162 (e.g., new voice spectrogram 162b) associated with the voice signal of the user 106 from a voice call 108. It may be noted that the term “new voice spectrogram 162b” refers to a voice spectrogram 162 of an unverified voice call 108. In other words, a new voice spectrogram 162b is a voice spectrogram 162 extracted from a voice call 108 where the identity of the calling user 106 has not yet been authenticated. To authenticate the identity of the user 106, the access manager 150 compares the new voice spectrogram 162b to a plurality of historic voice spectrograms 162a associated with verified voice signals of authorized users 106. In this context, the access manager 150 may have access to a plurality of historic voice spectrograms 162a (e.g., stored in memory 156), wherein each historic voice spectrogram 162a is a representation of a voice signal associated with a verified voice of a particular authorized user 106. Each historic voice spectrogram 162a is mapped to a unique user identity 164 of a particular authorized user 106. In other words, each historic voice spectrogram 162a represents a verified voice signal of an authorized user 106. In one embodiment, a historic voice spectrogram 162a may have been extracted from a previously verified voice call 108 of an authorized user 106. In this case, the historic voice spectrogram 162a is a representation of a voice signal associated with a verified voice call previously received from a particular authorized user 106 and known to be associated with the particular authorized user 106.

Comparing the new voice spectrogram 162b to the plurality of historic voice spectrograms 162a includes searching for one or more phonetic indicators 170 extracted from the new voice spectrogram 162b in each of the plurality of historic voice spectrograms 162a. When one or more of the phonetic indicators 170 match between the new voice spectrogram 162b and a particular historic voice spectrogram 162a, access manager 150 determines that the identity of the user 106 is authenticated. For example, when one or more of the phonetic indicators 170 extracted from the new voice spectrogram 162b match with respective one or more phonetic indicators 170 associated with a particular historic voice spectrogram 162a, access manager 150 determines that the user 106 to which the new voice spectrogram 162b belongs (e.g., the user who placed the voice call 108) is the authorized user 106 (e.g., as indicated by the user identity 164 mapped to the historic voice spectrogram 162a) mapped to the particular historic voice spectrogram 162a.

To search for a particular phonetic indicator 170 in a historic voice spectrogram 162a, the access manager 150 searches for a particular signal attribute 169 or a combination of two or more signal attributes 169 that correspond to (e.g., represents) the particular phonetic indicator 170. As described above, each phonetic indicator 170 may correspond to (e.g., is represented by) a particular signal attribute 169 or a combination of two or more signal attributes 169 of a voice spectrogram 162. For example, it is likely that a user 106 pronounces a particular word in a same or similar manner every time. The pronunciation of the particular word by the user 106 may be represented by a unique combination of signal values associated with two or more respective signal attributes 169 on a voice spectrogram 162 of the user’s voice. Access manager 150 may leverage the unique combination of values of the two or more signal attributes 169 to determine whether the same user 106 has spoken the particular word. For example, pronunciation of the particular word by the user 106 may be represented by a unique combination of respective values of voice modulation, frequency and pitch in a historic voice spectrogram 162a associated with a verified voice the user 106. When a new voice call 108 is subsequently received from the same user 106 in which the user 106 utters the same particular word, comparing the new voice spectrogram 162b of the new voice call 108 with the historic voice spectrogram 162a associated with the user 106 may yield a match between the same or similar combination of unique combination of respective values of voice modulation, frequency and pitch between the new voice spectrogram 162b and the historic voice spectrogram 162a. This match indicates that the user 106 who placed the new voice call is the same user 106 associated with the historic voice spectrogram 162a.

At operation 210, the access manager 150 determines, based on the comparison, whether one or more of the phonetic indicators extracted from the first voice spectrogram are found in one or more of the historic voice spectrograms. The access manager 150 verifies an identity of the first user based on whether the one or more of the phonetic indicators 170 extracted from the first voice spectrogram are found in the one or more of the historic voice spectrograms 162a. When no phonetic indicators extracted from the first voice spectrogram match with phonetic indicators from the historic voice spectrograms 162a, the method 200 proceeds to operation 212. On the other hand, when the one or more of the phonetic indicators extracted from the first voice spectrogram match with corresponding phonetic indicators from a historic voice spectrogram 162a, the method 200 proceeds to operation 214.

At operation 212, when a first historic voice spectrogram 162a includes the one or more of the phonetic indicators 170 extracted from the first voice spectrogram (e.g., new voice spectrogram 162b), the access manager 150 determines that the identity of the first user is authenticated.

At operation 214, when none of the historic voice spectrograms 162a include the one or more of the phonetic indicators 170 extracted from the first voice spectrogram (e.g., new voice spectrogram 162b), the access manager 150 determines that the identity of the first user is not authenticated.

As described above, the access manager 150 determines that the identity of a user 106 who placed the voice call 108 is authenticated in response to determining that at least a threshold number of phonetic indicators 170 extracted from the new voice spectrogram 162b match with respective phonetic indicators 170 associated with a particular historic voice spectrogram 162a. For example, when a threshold number of the phonetic indicators 170 extracted from the new voice spectrogram 162b match with respective phonetic indicators 170 associated with a particular historic voice spectrogram 162a, access manager 150 determines that the user 106 to which the new voice spectrogram 162b belongs (e.g., the user who placed the voice call 108) is the authorized user 106 (e.g., as indicated by the user identity 164 mapped to the historic voice spectrogram 162a) mapped to the particular historic voice spectrogram 162a.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. §112(f) as it exists on the date of filing hereof unless the words “means for” or “step for” are explicitly used in the particular claim.

1. A system comprising:
a memory that stores at least one historic voice spectrogram for each of a plurality of users, wherein each historic voice spectrogram is a representation of a voice signal associated with a verified voice of respective authorized user;
a processor communicatively coupled to the memory and configured to:
detect that a first voice call is initiated by a first user;
generate a first voice spectrogram of a first voice signal associated with the first voice call, wherein the first voice spectrogram is a representation of the first voice signal associated with the first voice call;
extract a plurality of phonetic indicators from the first voice spectrogram, wherein each phonetic indicator represents a characteristic of the first user’s voice as indicated by the first voice signal;
compare the first voice spectrogram with a plurality of the historic voice spectrograms associated with the plurality of the users, wherein the comparing comprises searching for each of the phonetic indicators extracted from the first voice spectrogram in each of the historic voice spectrograms;
determine, based on the comparison, whether one or more of the phonetic indicators extracted from the first voice spectrogram are found in one or more of the historic voice spectrograms;
verify an identity of the first user based on whether the one or more of the phonetic indicators extracted from the first voice spectrogram are found in the one or more of the historic voice spectrograms, wherein the verifying comprises:
when a first historic voice spectrogram comprises the one or more of the phonetic indicators extracted from the first voice spectrogram, determine that the identity of the first user is authenticated; and
when none of the historic voice spectrograms comprise the one or more of the phonetic indicators extracted from the first voice spectrogram, determine that the identity of the first user is not authenticated.

2. The system of claim 1, wherein:
the first voice call comprises a voice interaction between the first user and a second user associated with an interaction node that receives the first voice call; and
the processor is further configured to generate the first voice spectrogram in real-time or near real-time as the voice interaction is being conducted between the first user and the second user.

3. The system of claim 1, wherein the processor is further configured to:
input the first voice spectrogram and the plurality of historic voice spectrograms into a machine learning (ML) model, wherein the ML model is configured to identify matching phonetic indicators between voice spectrograms; and
determine using the ML model whether the one or more of the phonetic indicators extracted from the first voice spectrogram are found in the one or more of the historic voice spectrograms.

4. The system of claim 3, wherein the ML model is trained based on the plurality of historic voice spectrograms and identities of authorized users associated with each of the historic voice spectrograms.

5. The system of claim 1, wherein the phonetic indicators comprise one or more of pronunciation of one or more stop words, pronunciation of vowels, pronunciation of consonants, pronunciation of numerals, time taken to answer designated security questions, or voice modulation.

6. The system of claim 1, wherein the processor is further configured to determine that the identity of the first user is authenticated in response to detecting at least a threshold number of the phonetic indicators in the first historic voice spectrogram.

7. The system of claim 1, wherein the processor is further configured to:
receive, as part of the voice call, a request to perform a data interaction;
after the identity of the first user is authenticated:
determine whether the first user is authorized to perform the requested data interaction; and
in response to determining that the first user is authorized to perform the requested data interaction, process the requested first data interaction.

8. A method for authenticating users, the method comprising:
detecting that a first voice call is initiated by a first user;
generating a first voice spectrogram of a first voice signal associated with the first voice call, wherein the first voice spectrogram is a representation of the first voice signal associated with the first voice call;
extracting a plurality of phonetic indicators from the first voice spectrogram, wherein each phonetic indicator represents a characteristic of the first user’s voice as indicated by the first voice signal;
comparing the first voice spectrogram with a plurality of historic voice spectrograms associated with a plurality of users, wherein each historic voice spectrogram is a representation of a voice signal associated with a verified voice of respective authorized user, wherein the comparing comprises searching for each of the phonetic indicators extracted from the first voice spectrogram in each of the historic voice spectrograms;
determining, based on the comparison, whether one or more of the phonetic indicators extracted from the first voice spectrogram are found in one or more of the historic voice spectrograms;
verifying an identity of the first user based on whether the one or more of the phonetic indicators extracted from the first voice spectrogram are found in the one or more of the historic voice spectrograms, wherein the verifying comprises:
when a first historic voice spectrogram comprises the one or more of the phonetic indicators extracted from the first voice spectrogram, determine that the identity of the first user is authenticated; and
when none of the historic voice spectrograms comprise the one or more of the phonetic indicators extracted from the first voice spectrogram, determine that the identity of the first user is not authenticated.

9. The method of claim 8, wherein:
the first voice call comprises a voice interaction between the first user and a second user associated with an interaction node that receives the first voice call; and
further comprising generating the first voice spectrogram in real-time or near real-time as the voice interaction is being conducted between the first user and the second user.

10. The method of claim 8, further comprising:
inputting the first voice spectrogram and the plurality of historic voice spectrograms into a machine learning (ML) model, wherein the ML model is configured to identify matching phonetic indicators between voice spectrograms; and
determining using the ML model whether the one or more of the phonetic indicators extracted from the first voice spectrogram are found in the one or more of the historic voice spectrograms.

11. The method of claim 10, wherein the ML model is trained based on the plurality of historic voice spectrograms and identities of authorized users associated with each of the historic voice spectrograms.

12. The method of claim 8, wherein the phonetic indicators comprise one or more of pronunciation of one or more stop words, pronunciation of vowels, pronunciation of consonants, pronunciation of numerals, time taken to answer designated security questions, or voice modulation.

13. The method of claim 8, further comprising determining that the identity of the first user is authenticated in response to detecting at least a threshold number of the phonetic indicators in the first historic voice spectrogram.

14. The method of claim 8, further comprising:
receiving, as part of the voice call, a request to perform a data interaction;
after the identity of the first user is authenticated:
determining whether the first user is authorized to perform the requested data interaction; and
in response to determining that the first user is authorized to perform the requested data interaction, processing the requested first data interaction.

15. A non-transitory computer-readable medium storing instructions that when executed by a processor causes the processor to:
detect that a first voice call is initiated by a first user;
generate a first voice spectrogram of a first voice signal associated with the first voice call, wherein the first voice spectrogram is a representation of the first voice signal associated with the first voice call;
extract a plurality of phonetic indicators from the first voice spectrogram, wherein each phonetic indicator represents a characteristic of the first user’s voice as indicated by the first voice signal;
compare the first voice spectrogram with a plurality of historic voice spectrograms associated with a plurality of users, wherein each historic voice spectrogram is a representation of a voice signal associated with a verified voice of respective authorized user, wherein the comparing comprises searching for each of the phonetic indicators extracted from the first voice spectrogram in each of the historic voice spectrograms;
determine, based on the comparison, whether one or more of the phonetic indicators extracted from the first voice spectrogram are found in one or more of the historic voice spectrograms;
verify an identity of the first user based on whether the one or more of the phonetic indicators extracted from the first voice spectrogram are found in the one or more of the historic voice spectrograms, wherein the verifying comprises:
when a first historic voice spectrogram comprises the one or more of the phonetic indicators extracted from the first voice spectrogram, determine that the identity of the first user is authenticated; and
when none of the historic voice spectrograms comprise the one or more of the phonetic indicators extracted from the first voice spectrogram, determine that the identity of the first user is not authenticated.

16. The non-transitory computer-readable medium of claim 15, wherein:
the first voice call comprises a voice interaction between the first user and a second user associated with an interaction node that receives the first voice call; and
the instructions further cause the processor to generate the first voice spectrogram in real-time or near real-time as the voice interaction is being conducted between the first user and the second user.

17. The non-transitory computer-readable medium of claim 15, wherein the instructions further cause the processor to:
input the first voice spectrogram and the plurality of historic voice spectrograms into a machine learning (ML) model, wherein the ML model is configured to identify matching phonetic indicators between voice spectrograms; and
determine using the ML model whether the one or more of the phonetic indicators extracted from the first voice spectrogram are found in the one or more of the historic voice spectrograms.

18. The non-transitory computer-readable medium of claim 17, wherein the ML model is trained based on the plurality of historic voice spectrograms and identities of authorized users associated with each of the historic voice spectrograms.

19. The non-transitory computer-readable medium of claim 15, wherein the phonetic indicators comprise one or more of pronunciation of one or more stop words, pronunciation of vowels, pronunciation of consonants, pronunciation of numerals, time taken to answer designated security questions, or voice modulation.

20. The non-transitory computer-readable medium of claim 15, wherein the instructions further cause the processor to determine that the identity of the first user is authenticated in response to detecting at least a threshold number of the phonetic indicators in the first historic voice spectrogram.
